(19) United States
(12) Patent Application Publication
(10) Pub. No.: US 2009/0224002 A1
(43) Pub. Date: Sep. 10, 2009

(54) Squeezable Partition Bottle and Bag

(76) Inventor: Joseph Wadih Bakhos, Sugarloaf, CA (US)

Correspondence Address: Joseph W. Bakhos, PO Box 1506, Big Bear City, CA, 92314, US

(21) Appl. No.: 12/110,370

(22) Filed: Apr. 28, 2008

Related U.S. Application Data
(60) Provisional application No. 61/068,442, filed on Mar. 7, 2008.

(51) Int. Cl. B65D 37/00; B67D 5/42

(52) U.S. Cl. 222/209; 222/386.5

(57) ABSTRACT

This invention is a squeeze bottle that forces all of the liquid to be dispensed at the top of the bottle. The invention also prohibits air from contacting the liquid to be dispensed. This bottle is composed of the following: A top cap has a nozzle with a one-way valve allowing liquid to leave the container. A bottom cap employs a one-way valve that allows air to enter an airbag. The caps attach to the body of the squeeze bottle. The liquid is in a bag that is referred to as the first chamber. This first chamber is airtight with the only egress for the liquid being through the top one-way valve. The bottom chamber is an airbag distinct from the liquid bag. This second bag forms a distinct second chamber that is also airtight. The second chamber communicates exclusively to the outside air, only allowing air in through the one-way valve at the bottom. The arrangements of the bottle and the two bags create a third chamber, called the vacuum chamber, which is also airtight and which communicates with no other chamber and also does not communicate with the outside air. Different embodiments of this invention employ different means in order to achieve three separate chambers.

### CROSS-REFERENCE TO RELATED APPLICATIONS

Provisional application No. 61/068,442 filed on Mar. 7, 2008

### REFERENCES CITED

### U.S. Patent Documents

| | | | | |
|---|---|---|---|---|
| 3,319,837 | A | May 1967 | Mueller | 222/212 |
| 4,239,132 | A | December 1980 | Mueller et al. | 222/212 |
| 4,760,937 | A | August 1988 | Evezich | 222/95 |
| 5,687,882 | A | November 1997 | Mueller | 222/212 |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to a squeezable container that forces the liquid to be dispensed toward the top of the container at all times. The container also prohibits exposure of the liquid in the container to air.

Most squeeze bottles necessarily allow air into the bottle as the liquid is dispensed out of the bottle. This exposes the liquid to contamination. When exposed to air, some liquids can cure (glue for example), causing the nozzle of the container to become clogged. Also, whether because of contamination or curing, the shelf life of the liquid is reduced by the entry of air to mix with it. One additional problem is that once the bottle is set upon its base, the liquid falls to the bottom of the bottle. With some thick liquids, this means that the bottle must be shaken to get the liquid to the nozzle before the liquid is dispensed again. Lastly, the liquid clinging to the sides of the bottle is unsightly. For this reason, most squeeze bottles are made of some sort of opaque plastic.

U.S. Pat. No. 4,239,132 uses two one-way valves and an air bladder to try to force the liquid out of the bottle. This design creates two airtight chambers within the bottle. The problem with this design is that liquid can be trapped far away from the nozzle. The liquid becomes trapped because there is no control over how the air bladder inflates. The air bladder will often inflate in a way that traps some of the liquid far away from the nozzle. Then the trapped liquid can no longer be dispensed.

U.S. Pat. No. 4,760,937 is similar to the previous cited invention. This invention also employs two one-way valves and also divides the interior of the bottle into two chambers. The difference is that U.S. Pat. No. 4,760,937 puts the liquid into a bag. The air entering the rear chamber still displaces the liquid. The problem with this design is that there is no control over the way in which the bag containing the liquid will compress. Often the bag will compress in a way that blocks the nozzle and then prohibits all of the liquid from being dispensed.

U.S. Pat. Nos. 5,687,882 and 6,364,163 are similar to U.S. Pat. No. 4,239,132 in that they employ one-way valves and an air bladder to displace the liquid. They are different than the first invention in that they both employ a column attached to a sliding collar (sometimes with a piston) in order to try to control the deployment of the air bladder. Both of these inventions also divide the interior of the bottle into two chambers. There are a few problems with these inventions. The first problem is that when the bottle is squeezed the bladder will not neatly deploy as envisioned. Sometimes, a bubble of liquid will force itself behind the piston or collar; this bubble of liquid will end up being trapped remote from the nozzle. The bubbling and trapping issue seen in all prior inventions is intrinsic to any design where the interior of the bottle is divided topologically into only two chambers. In any two-chambered design there arises a contradiction: If the plunger is made too tight, then too much force is required to move it. If the plunger is made too loose (or if the plunger is flexible, or if there is no plunger) then some liquid will bubble through to the other side of the plunger during operation. This difficulty can only be resolved with by the mechanism introduced by the present invention: the interior of the bottle must be divided topologically into three chambers rather than two. An additional problem with U.S. Pat. Nos. 5,687,882 and 6,364,163 are their complexity: The costs of producing these bottles and packaging liquid in them are prohibitive.

### SUMMARY OF THE INVENTION

An object of the present invention is to provide a container that alleviates the drawbacks discussed in regards to the existing inventions. This new type of bottle will be inexpensive to manufacture and package in. This bottle will prohibit outside air from contacting the packaged liquid during dispensing. This will increase shelf life and sanitation as well as eliminating the problems associated with air-cured liquid such as clogged nozzles. This bottle will also be easy to use; it will not be necessary to shake the bottle or to store the bottle upside-down in order to use it. This bottle will also be aesthetically pleasing; all of the liquid might be packaged in a clear container where the liquid is always neatly forced to the top of the container.

All embodiments contain a top cap itself containing a nozzle with a one-way valve allowing liquid to leave the container. This top may be removably attached to the container. All embodiments contain a bottom cap that has a one-way valve in it. This bottom cap may be removably attached to the body of the container. All embodiments have three chambers.

Chamber one is the bag containing the liquid. This bag is airtight with no ingress. The only egress is the one-way valve at the top where the liquid can escape. The top cap presses the lip of the liquid bag between the top cap and the body of the container, creating an airtight seal.

Chamber two is the bag containing the air. This bag is airtight with no egress. The only ingress is the one-way valve in the bottom cap. The bottom cap presses the lip of the airbag between the bottom cap and the body of the container.

Chamber three is the vacuum chamber that is within the bottle but not within either bag. Both bags and the seals at each end of the bottle create this chamber.

According to at least one embodiment of the invention, there may be a plunger between the bags to ensure that the two separate bags do not become entangled.

According to at least one embodiment of the invention, there may be one single bag that is molded of one piece that has two separate chambers.

According to at least one embodiment of the invention, there may be one single molded part that is essentially a single bag with two chambers along with a plunger between the two chambers.

### BRIEF DESCRIPTION OF THE DRAWINGS

FIG. 1 shows the embodiment employing two bags before squeezing.

FIG. 2 shows the same embodiment being squeezed after some of the liquid has been dispensed.

FIG. 3 shows an embodiment that has two bags with a separate plunger between them.

FIG. 4 shows this same embodiment being squeezed after some of the liquid has been dispensed.

FIG. 5 shows an embodiment that has a single bag that is divided into two separate chambers by a dividing wall that is molded of one piece with the bags. The two chambers open outward to the two opposite ends.

FIG. 6 shows this same embodiment being squeezed after some of the liquid has been dispensed.

FIG. 7 shows an embodiment where the two chambers and a plunger are all one single molded piece.

FIG. 8 shows this same embodiment being squeezed after some of the liquid has been dispensed.

FIG. 9 shows a collapsed close up of the embodiment depicted in FIG. 5 and FIG. 6.

FIG. 10 shows the two-chambered bag depicted in FIG. 5 and FIG. 6. In this drawing the two-chambered bag is shown alone before it is put into the bottle.

FIG. 11 shows the two-chambered bag depicted in FIG. 7 and FIG. 8. This two-chambered bag is molded of one piece with a plunger wall dividing the two chambers from each other. In this drawing the two-chambered bag is shown alone before it is put into the bottle.

### DETAILED DESCRIPTION OF PREFERRED EMBODIMENTS

Note: Numbers in parenthesis refer to notes on the drawings. Any given number will refer to the same part on all drawings, figures, and embodiments. For example, the number (6) refers to the upper one-way valve on all of the drawings and figures and embodiments. The drawings are ⅔ actual size.

FIG. 1 shows the embodiment with two separate distinct bags (1 and 2) without any sort of plunger between them. The bottle is comprised of a top cap (3) that has a nozzle (4) wherein there is a one-way valve (6) for the egress of the liquid. This one-way valve will not allow any air into the top. There is a top bag (1) containing the liquid to be dispensed. The lip of this top bag (7) is held in an airtight seal by the pressure of the cap (3) upon the body of the bottle (8). When the bottle is squeezed, the liquid is forced out through the one-way valve at the top (6). There is also a bottom cap (9) that has a shorter nozzle (10) that is directed inward, wherein there is a one-way valve (11) for the ingress of air into the airbag (2). This one-way valve will allow air into the airbag, but will not allow any air to escape from the airbag. The lip (12) of the airbag is held in an airtight seal by the pressure of the bottom cap (9) upon the body of the bottle (8). The seals at the ends of the bottle, the body of the bottle, and the two bags, all combine to create three different chambers in the bottle: The liquid bag (1) creates the liquid chamber (13). The airbag (2) creates the air chamber (14). The sides of the bottle create a vacuum chamber (15) between it and the two bags.

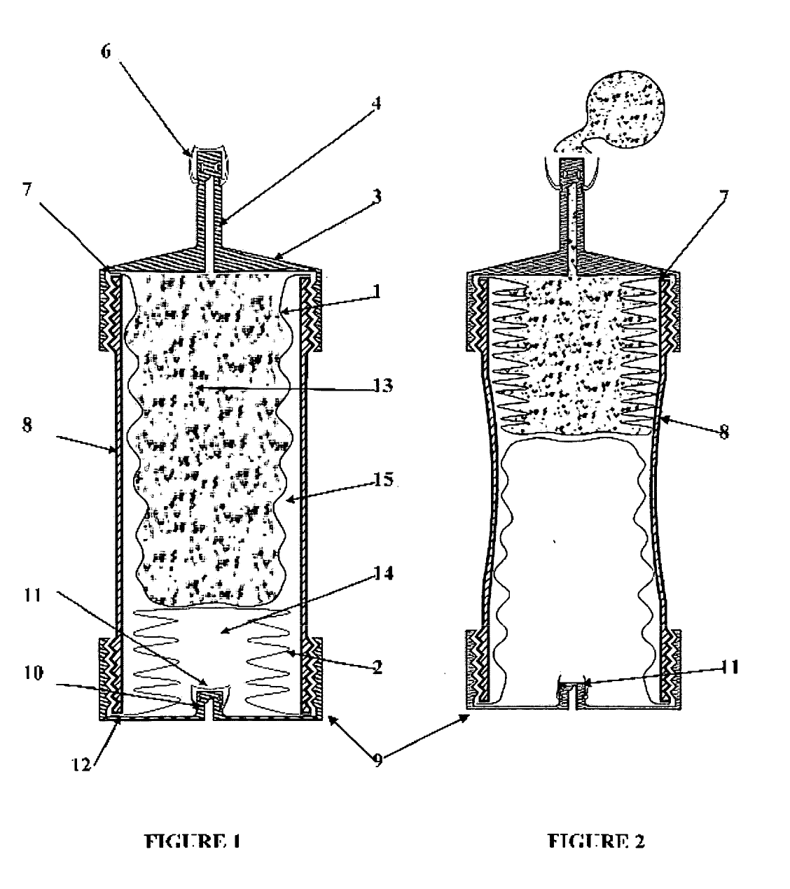

FIG. 2 shows the bottle being squeezed. When it is squeezed, liquid is forced out through the one-way valve at the top (6). While it is being squeezed, the bottom air valve (11) is forced shut, not allowing any air to escape. When the bottle is released, the plastic will snap back to its original shape, creating a vacuum inside the bottle. This vacuum within the bottle will cause air to enter through the one-way valve at the bottom (11), thereby filling the airbag (2).

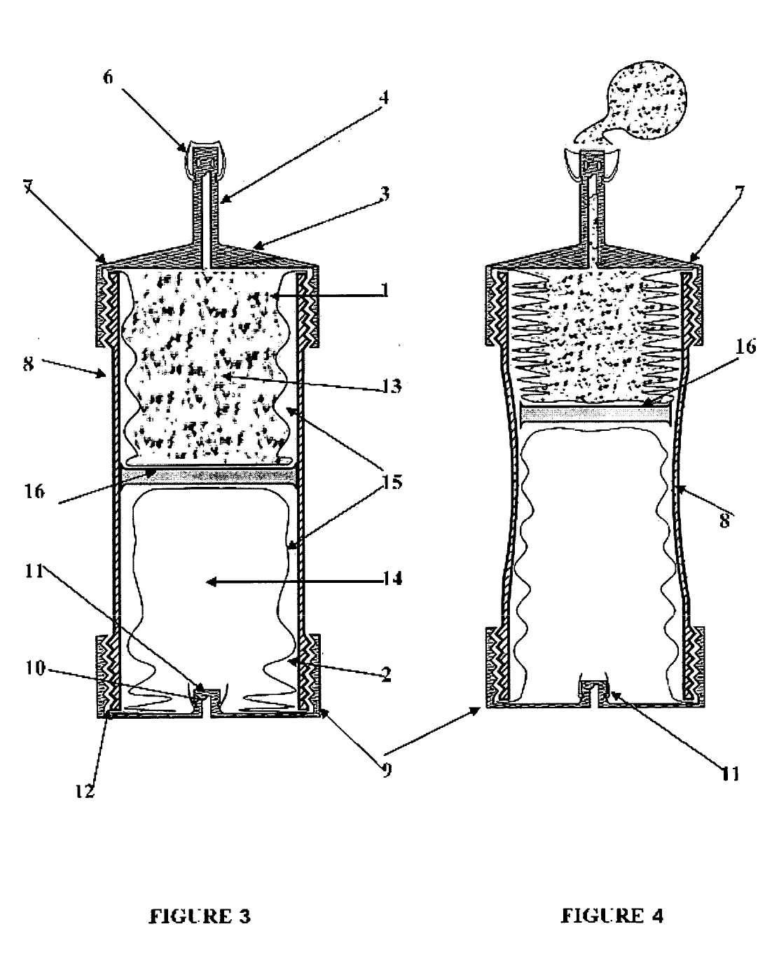

FIG. 3 shows the embodiment with a plastic plunger (16) between the bags (1 and 2). The operation of the valves in conjunction with the squeezing action on the bottle is the same as the first embodiment. Having a loose plunger (16) between the bags may be useful in that it may prevent one bag from sliding past the other. The plunger might be of a compressible or non-compressible material. FIG. 4 shows this same version being squeezed.

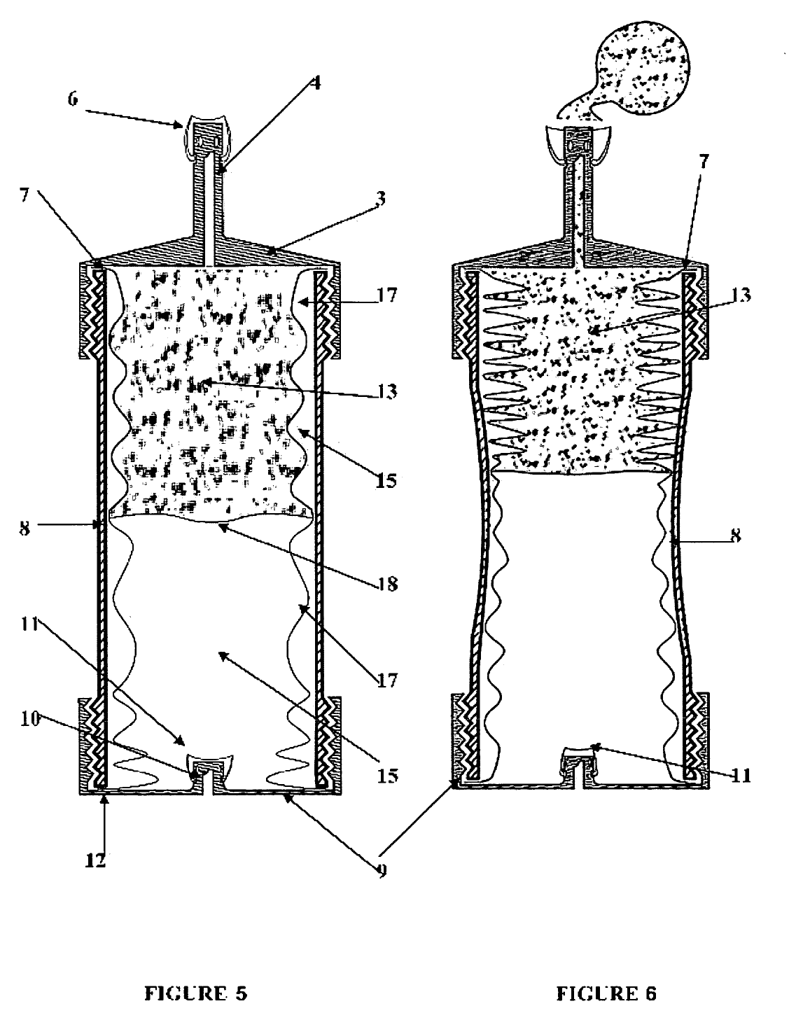

FIG. 5 shows an embodiment using a new type of bag (17). This new type of bag is to be used in conjunction with this invention. The bag is sealed in the middle by a separating wall (18), but open at both ends, thereby creating a separate upper chamber (13) and a separate lower chamber (14), along with a vacuum chamber (15). The upper chamber (13) of the bag is filled with the liquid, as per the other embodiments. The lip of the upper chamber (7) of the bag will be sealed between the upper cap (3) and the body of the plastic bottle (8), as per the other embodiments. The lower chamber (14) is formed by the airbag (2), and it is sealed (12) between the lower cap (9) and the lower end of the body of the bottle (8) as per the other embodiments. The valves and squeezing action work in the same way as the other embodiments. Because this two-chambered bag (17) is molded all of one piece, there is no way for the air chamber (14) to partly bypass or become tangled with the liquid chamber (13). FIG. 6 shows this same embodiment being squeezed.

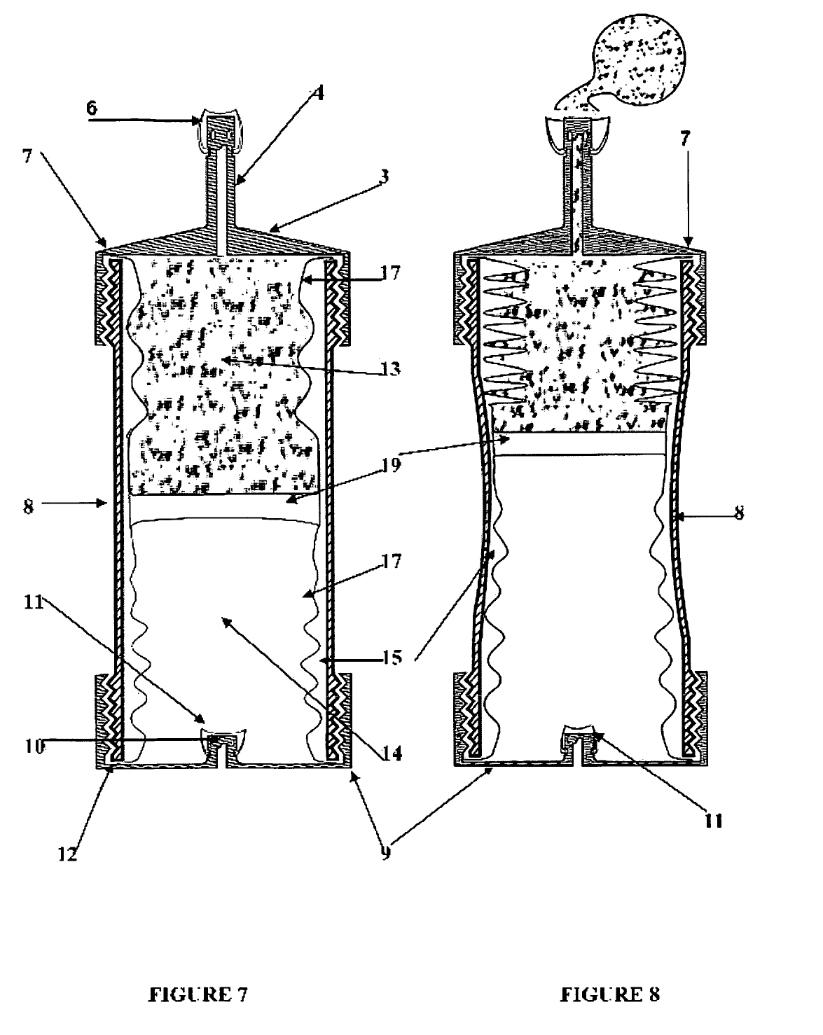

FIG. 7 shows an embodiment using a minor variation of the new type of bag (17). In this case the dividing wall (19) between the two chambers is made thicker; thick enough that it becomes a sort of plunger even though it is of one molded piece with the two-chambered bag itself. The advantage of this embodiment is that with especially viscous materials the plunger (19) will prevent the two chambers (13 and 14) from bubbling into each other or deforming too much when the bottle is squeezed. The operation of the valves and the squeezing action is the same as per the other embodiments. FIG. 8 shows this same embodiment being squeezed.

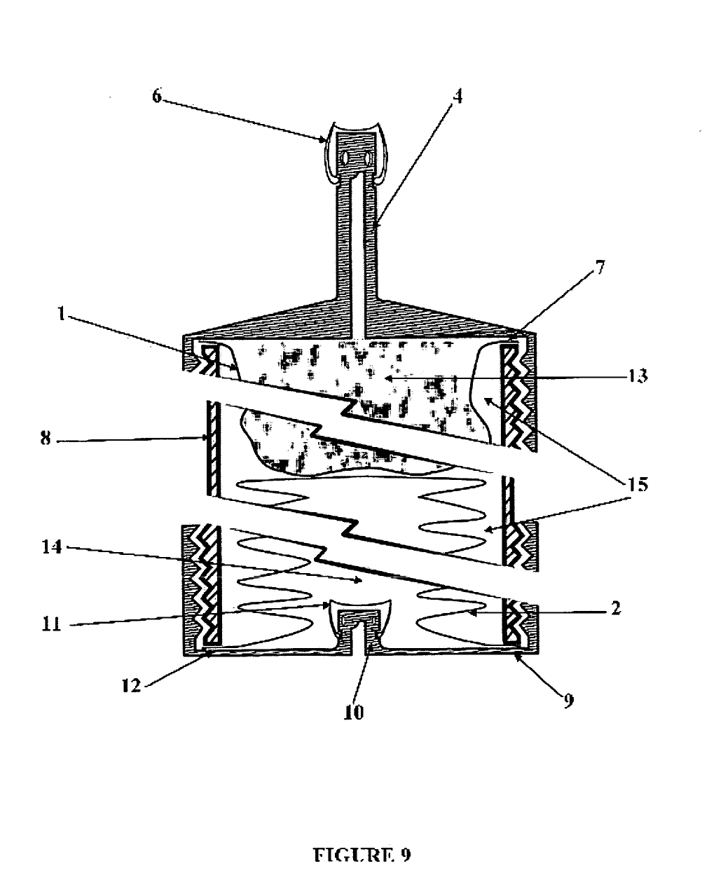

FIG. 9 shows a close-up of the first embodiment. In this view it is more readily apparent that the lip (7) of the upper liquid bag is sealed between the body of the plastic bottle (8) and the upper cap (3), while the lip (12) of the airbag is sealed between the body of the plastic bottle (8) and the lower cap (9). The drawing shows the bottle after it has been squeezed and then released. Because of this, the upper valve (6) is sealed and no liquid is getting out through the top. At this time, the lower valve (11) is open and air is being sucked into the airbag (2).

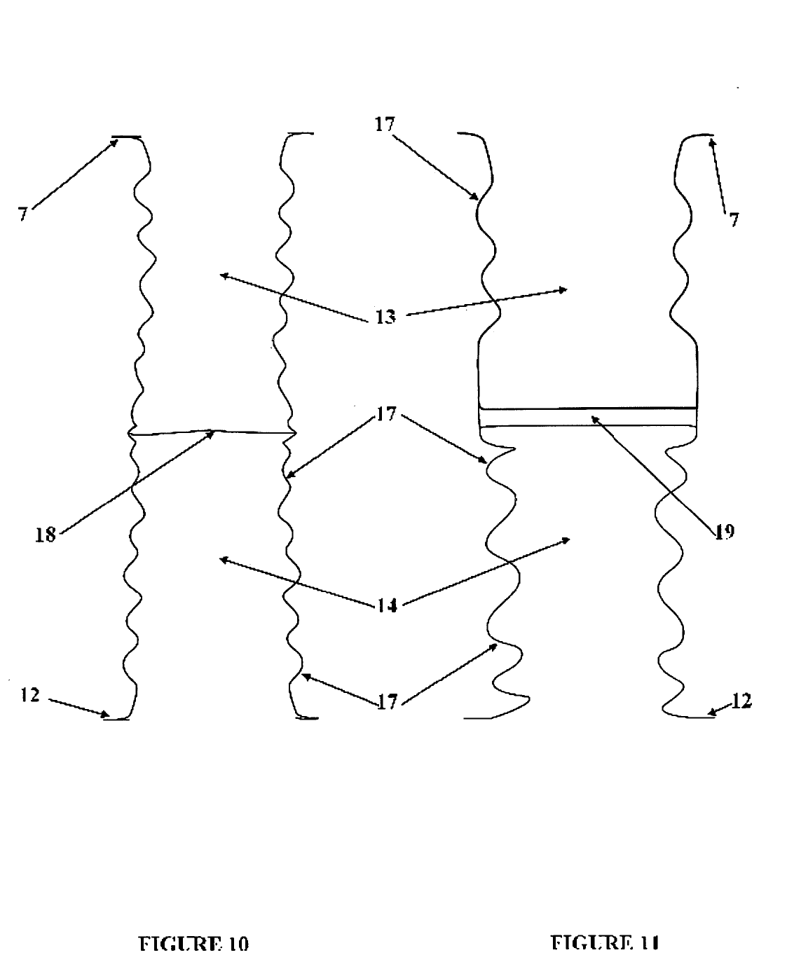

FIG. 10 shows a two-chambered bag (17) alone apart from the bottle. The upper chamber (13) would be filled with liquid; then the bag would be set into the body of the bottle. Then the caps would be put on the bottle in order to seal both ends of the two-chambered bag. FIG. 11 shows the variation of the two-chambered bag wherein the dividing wall (19) is thick enough to be considered a sort of plunger even though it is of one molded piece with the walls of the two-chambered bag (17).

The present invention is not limited to the described embodiments but can be modified in many different ways without departing from the scope of the appended claims.

What is claimed is:

1. A container for dispensing liquids of varying viscosity, the container comprising:
A flexible hollow body.
A one-way valve at the top whereby the liquid escapes but no air can get in.
A one-way valve at the bottom whereby air can enter the container but no air can escape.
An arrangement of flexible bag (or bags) on the interior of the container arranged in such a way that the interior is divided topologically into three separate airtight chambers: the liquid chamber, the air chamber, and the vacuum chamber. The liquid chamber communicates only to the outside, and this is done only through the one-way valve at the top. The air chamber only communicates with the outside, and this is done only through the one-way valve at the bottom. The vacuum chamber communicates with no other chamber and does not communicate with the outside.

2. A new type of bag for use with the bottle described in claim one. This new type of bag is sealed in the middle and open on both ends.

3. A container according to claim one wherein there is a plunger either inserted between the two chambers, or else the plunger is molded of one piece with the two chambers forming a new type of bag according to claim two.
